(19) United States
(12) Patent Application Publication
(10) Pub. No.: US 2026/0201732 A1
(43) Pub. Date: Jul. 16, 2026

(54) BOLT LOCK

(71) Applicant: Steves & Sons, Inc., San Antonio, TX (US)

(72) Inventors: Austin James PAYNE, Adkins, TX (US); Angel Villanueva MARTINEZ, San Antonio, TX (US); Joseph OLVERA, San Antonio, TX (US)

(73) Assignee: Steves & Sons, Inc., San Antonio, TX (US)

(21) Appl. No.: 19/022,714

(22) Filed: Jan. 15, 2025

(51) Int. Cl. E05B 55/00; E05C 1/00; E05C 1/04

(52) U.S. Cl. CPC E05B 55/00; E05C 1/006; E05C 1/04

(57) ABSTRACT

This disclosure is directed to a bolt lock, a door including the bolt lock, and a method of installing the bolt lock. The bolt lock can include: a housing including a cavity; a bolt at least partially within the cavity, the bolt translating between a retracted position and an extended position, relative to the housing, in response to manual engagement, the bolt including a first end, a second end to selectively engage a recess of a door frame, a longitudinal axis extending from the first end to the second end, a substantially circular cross section, and a first hole to receive a fastener and allow the bolt to translate relative to the fastener between the retracted position and the extended position, the first hole having a length, as measured along the longitudinal axis, greater than or equal to 1.5 inches and less than or equal to 4 inches.

### FIELD

This disclosure relates to bolt locks, for example, flush bolt locks for doors.

### BACKGROUND

Bolt locks are often used to enhance the security of a door or window. Flush bolt locks are often used in a double door configuration to secure a first door relative to a frame and enable a second door to be secured to the first door via another lock.

Additionally, bolt locks can enhance the strength of a door or window against high winds in areas more prone to severe weather (e.g., hurricanes, tornados, etc.). It can be difficult to create bolt locks that provide a high level of security but yet are aesthetically pleasing and easy to operate.

### BRIEF SUMMARY

In some embodiments, a bolt lock for a door can include a housing including a cavity and an opening exposing a portion of the cavity; a bolt at least partially within the cavity, the bolt translating between a retracted position and an extended position along a translation axis, relative to the housing, in response to manual engagement via the opening, the bolt including a first end, a second end to selectively engage a recess of a door frame, a longitudinal axis extending from the first end to the second end, a substantially circular cross section, and a first hole to receive a fastener and allow the bolt to translate relative to the fastener between the retracted position and the extended position, the first hole having a length, as measured along the longitudinal axis, greater than or equal to 1.5 inches and less than or equal to 4 inches.

In some embodiments, a door can include a stile including a cavity; a bolt lock at least partially within the cavity, the bolt lock including: a housing including a cavity and an outward facing surface facing away from the stile; a knob that translates between a first knob position and a second knob position; and a bolt coupled to the knob and at least partially within the cavity of the housing, the bolt translating between a retracted position and an extended position along a translation axis, relative to the housing, in response to manual engagement of the knob from the first knob position to the second knob position; the door further including an astragal attached to the stile and covering a portion of the bolt lock, the astragal including an opening aligned with the first and second knob positions, the knob translating within the opening of the astragal.

In some embodiments, a method of installing a bolt lock can include forming a cavity in a stile and inserting the bolt lock into the cavity, the bolt lock including: a housing including a cavity, an outward facing surface configured to face away from the stile, and an opening exposing a portion of the cavity of the housing; a bolt at least partially within the cavity of the housing; and a knob coupled to the bolt adjacent the opening, the bolt translating between a retracted position and an extended position, relative to the housing, in response to manual engagement of the knob; the method further including forming an opening in an astragal; aligning the opening of the astragal with the opening of the housing; and attaching the astragal to the stile, the knob translating within the opening of the astragal when the astragal is attached to the stile.

### BRIEF DESCRIPTION OF THE DRAWINGS

The accompanying figures, which are incorporated herein, form part of the specification and illustrate embodiments of this disclosure. Together with the description, the figures further serve to explain the principles of and to enable a person skilled in the relevant arts to make and use the invention(s).

FIG. 1 depicts a front view of exemplary doors according to some embodiments.

FIG. 2 depicts a portion of an exemplary door according to some embodiments.

FIG. 3 depicts a front perspective view of an exemplary bolt lock according to some embodiments.

FIG. 4 depicts a perspective view of an exemplary bolt according to some embodiments.

FIG. 5 depicts a perspective view of the exemplary bolt of FIG. 4, in combination with an exemplary pin and knob, according to some embodiments.

FIG. 6 depicts a perspective view of the exemplary knob of FIG. 5, according to some embodiments.

FIG. 7 depicts a front view of a portion of the exemplary bolt lock of FIG. 3, according to some embodiments.

FIG. 8 depicts a rear perspective view of the exemplary bolt lock of FIG. 3, according to some embodiments.

FIG. 9 depicts an exemplary method of installing a bolt lock according to some embodiments.

FIG. 10 depicts the exemplary method of installing a bolt lock of FIG. 9, according to some embodiments.

### DETAILED DESCRIPTION

Embodiments of the present invention(s) will now be described in detail with reference to embodiments thereof as illustrated in the accompanying drawings. References to “one embodiment,” “an embodiment,” “an example embodiment,” “some embodiments,” “exemplary,” etc., indicate that the embodiment described can include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

Unless clearly indicated to the contrary (e.g., “either x or y, but not both x and y”) or readily contextually apparent, the term “or” as used herein is inclusive (i.e., “x or y” includes just x, just y, and x and y, and “x, y, or z” includes just x, just y, just z, and any combination thereof). Moreover, such phrases are not necessarily referring to the same embodiment.

The term “about” or “substantially” or “approximately” as used herein means the value of a given quantity that can vary based on a particular technology. Based on the particular technology, the term “about” or “substantially” or “approximately” can indicate a value of a given quantity that varies within, for example, 0.1-10% of the value (e.g., ±0.1%, ±1%, ±2%, ±5%, or ±10% of the value).

Numerical values, including endpoints of ranges, can be expressed herein as approximations preceded by the term “about,” “substantially,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint. Additionally, it will be further understood that a range expressed as “between” “X” and “Y” includes any value interposed by X and Y as well as X and Y.

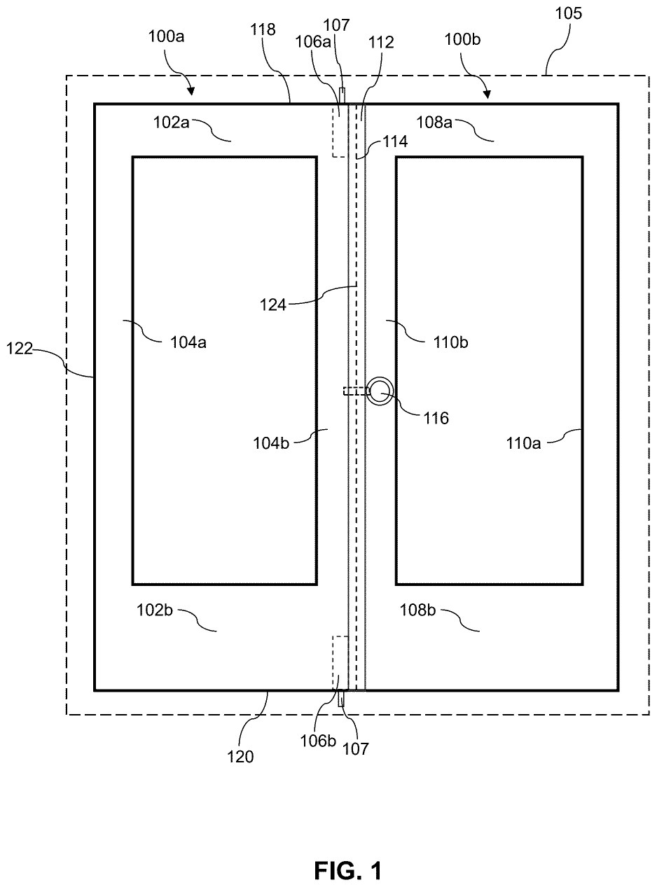

FIG. 1 shows a front view of a first door 100a and a second door 100b according to some embodiments. In embodiments in which first and second doors 100a-b can be locked to prevent entry, that FIG. 1 shows a “front” view of first and second doors 100a-b means that FIG. 1 shows a locked (or lockable) side of first and second doors 100a-b. That is, entry through first and second doors 100a-b in the view of FIG. 1 can require a key or similar access implement (passcode, fingerprint, etc.) and/or unlocking by a user on the other side of first and second doors 100a-b. In some embodiments, first and second doors 100a-b can be exterior doors. In some embodiments, first and second doors 100a-b can be interior doors (e.g., hallway doors).

In some embodiments, first and second doors 100a-b can be double doors. Accordingly, first door 100a and second door 100b can form a seam 114 when in a closed position. In some embodiments, a gap between first and second doors 100a-b can exist at seam 114. In some embodiments, first door 100a or second door 100b can include an astragal 112 to cover seam 114. In some embodiments, first door 100a can include astragal 112. In such embodiments, first and second doors 100a-b can be inswing doors in the view of FIG. 1 (i.e., first and second doors 100a-b swing into the page to open in the view of FIG. 1). In some embodiments, second door 100b can include astragal 112. In such embodiments, first and second doors 100a-b can be outswing doors in the view of FIG. 1 (i.e., first and second doors 100a-b swing out of the page to open in the view of FIG. 1). In some embodiments, astragal 112 is omitted.

In some embodiments, first door 100a can be an “inactive door,” that is, the door that does not have a doorknob in a particular double door configuration.

First door 100a can include at least a first rail 102a and a second rail 102b. First door 100a can also include at least a first stile 104a and a second stile 104b. First door 100a can be rotatably attached to a frame 105 at a first side edge 122 of first door 100a. Accordingly, in some embodiments, first stile 104a can be a frame-adjacent stile and second stile 104b can be a door-adjacent stile (that is, adjacent to second door 100b).

First door 100a can include a variety of materials (e.g., wood, fiberglass, etc.) and can be in any desired configuration. Accordingly, rails 102 and stiles 104 need not be separate components. Instead, first and second rails 102a-b can refer generally to portions of first door 100a adjacent top and bottom edges 118, 120 of first door 100a, respectively, but not extending to either of first or second side edges 122, 124 of first door 100a. Similarly, first and second stiles 104a-b can refer generally to portions of first door 100a adjacent first and second side edges 122, 124, respectively, and extending to top and bottom edges 118, 120 of first door 100a.

In some embodiments, second side edge 124 can be an edge of first door 100a to which astragal 112 is attached, though astragal 112 can be considered part of first door 100a. Top and bottom edges 118, 120 can be edges of first door 100a to which other components (e.g., insulation strips, door draft stoppers, door sweeps, etc.) can be attached.

First door 100a can include one or more bolt locks 106. In some embodiments, the one or more bolt locks 106 can be flush bolt locks having an outward facing housing surface that is substantially even with a surface of a stile in which they are installed. In some embodiments, first door 100a can include a first bolt lock 106a adjacent top edge 118 and/or a second bolt lock 106b adjacent bottom edge 120. In some embodiments, a bolt lock 106 can be positioned in a cavity of second stile 104b. The bolt lock 106 can include a bolt 107 that can translate between a retracted position and an extended position. Bolt 107 is shown in the extended position in FIG. 1. When bolt 107 is translated from the retracted position to the extended position, it can engage a recess of frame 105 (e.g., a recess of a catch installed on frame 105) to secure first door 100a relative to frame 105.

In some embodiments, bolt 107 can extend beyond an edge of first door 100a (either top or bottom edge 118, 120) in the extended position by a distance of greater than or equal to 1.5 inches and less than or equal to 4 inches. More specifically, in some embodiments, the distance can be greater than or equal to 1.75 inches and less than or equal to 2.25 inches, greater than or equal to 2 inches and less than or equal to 4 inches, or greater than or equal to 4 inches and less than or equal to 6 inches.

In some embodiments, bolt 107 can extend through frame 105 in the extended position. In such embodiments, bolt 107 (e.g., of second bolt lock 106b) can engage a recess of a foundation of the structure in which first door 100a is installed. Additionally or alternatively, bolt 107 (e.g., of first or second bolt lock 106a, 106b) can engage another component adjacent frame 105, for example, a recess of a stud of the structure used to support frame 105.

Second door 100b can include similar features to first door 100a. For example, second door 100b can include at least first and second rails 108a-b similar to first and second rails 102a-b and at least first and second stiles 110a-b similar to first and second stiles 104a-b. In some embodiments, second door 100b can include a lock 116 to secure second door 100b to first door 100a. In some embodiments, lock 116 can be a knob lock. In some embodiments, lock 116 can be a cylinder lock, a hand lever lock, a mortise lock, and/or a chain lock, etc. Accordingly, in some embodiments, first and second doors 100a-b can be secured in the closed position at three points: the two points of engagement of bolts 107 with frame 105 and the point of engagement of lock 116 with first door 100a.

While FIG. 1 shows two doors 100a-b, in some embodiments, first and second doors 100a-b can be first and second windows 100a-b. In some of such embodiments, a first window 100a may not include an astragal 112.

While FIG. 1 shows second door 100b including lock 116, in some embodiments, first door 100a can include lock 116. Further, while FIG. 1 shows first door 100a on the left from the front view of FIG. 1, the positions of first door 100a and second door 100b can be switched.

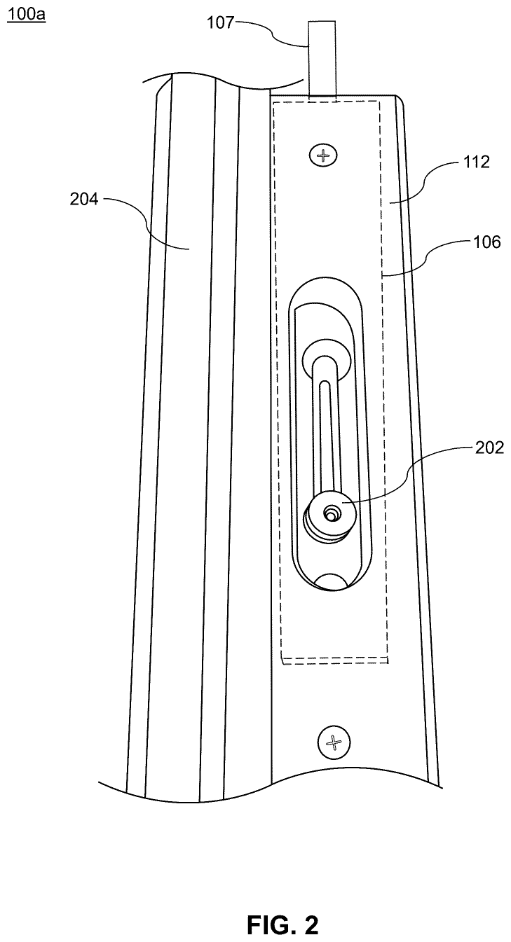

While FIG. 1 shows a double door configuration, in some embodiments, first door 100a can be a single door 100a including bolt lock(s) 106 and/or lock 116. In such embodiments, actuation features of the bolt lock(s) 106 can be exposed on a rear surface of second stile 104b (opposite the surface shown in FIG. 1), rather than on side edge 124 as shown in FIG. 2. This can allow access to the actuation features when the single door 100a is closed. In some of such embodiments, lock 116 can further secure the single door 100a to frame 105.

While FIG. 1 shows a vertically oriented bolt lock 106, in some embodiments, a bolt lock 106 can be horizontally oriented such that its bolt 107 extends horizontally into frame 105 (e.g., in a single door configuration). In some of such embodiments, the bolt lock 106 may be installed in second stile 104b but may extend into a rail 102, depending on the length of the bolt lock 106.

FIG. 2 shows a bolt lock 106 installed in first door 100a according to some embodiments. Astragal 112 shown in FIG. 2 is installed on second side edge 124 of first door 100a. Astragal 112 can include a flange portion 204 to cover seam 114 shown in FIG. 1. As shown in FIG. 2, in some embodiments, astragal 112 can cover at least a portion of bolt lock 106.

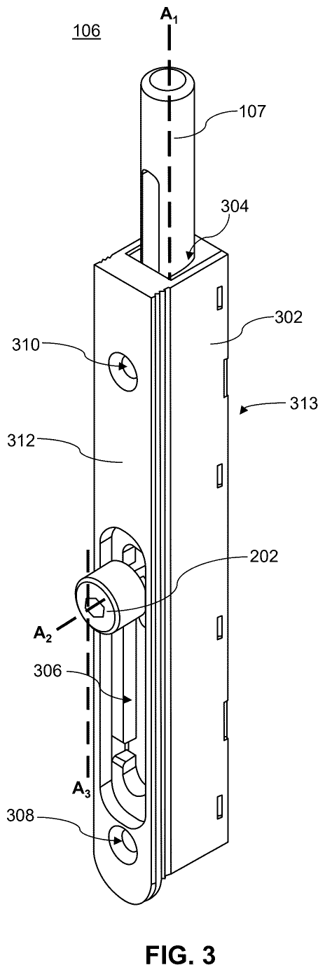

Bolt lock 106 shown in FIG. 2 can be either first bolt lock 106a or second bolt lock 106b. As shown in FIG. 2, bolt lock 106 can include a knob 202 for manual engagement. For example, users can grasp knob 202 with their fingers and move knob 202. Knob 202 can be coupled to bolt 107. Accordingly movement of knob 202 between a first knob position (shown in FIG. 2) and a second knob position (shown in FIG. 3) can translate bolt 107 between the retracted position and the extended position.

FIG. 3 shows a bolt lock 106 according to some embodiments. Bolt lock 106 shown in FIG. 3 can be either first bolt lock 106a or second bolt lock 106b.

As shown in FIG. 3, bolt lock 106 can include a housing 302. In some embodiments, housing 302 can be made of a metal, for example, an aluminum alloy, cold rolled steel (CRS), brass, a copper alloy, stainless steel, a titanium alloy, etc. In some embodiments, housing 302 can be made of a plastic, for example, high-density polyethylene (HDPE), polycarbonate (PC), nylon, carbon fiber reinforced plastic (CFRP), acrylonitrile butadiene styrene (ABS), polyetheretherketone (PEEK), etc. In some embodiments, housing 302 can be made of a composite material (e.g., of two metals, a metal and a plastic, and/or two plastics).

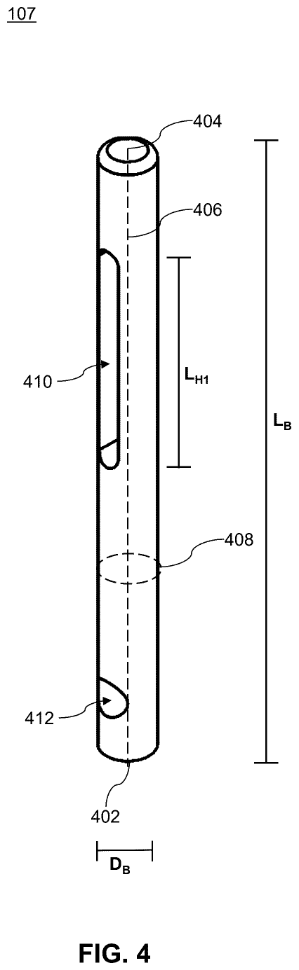

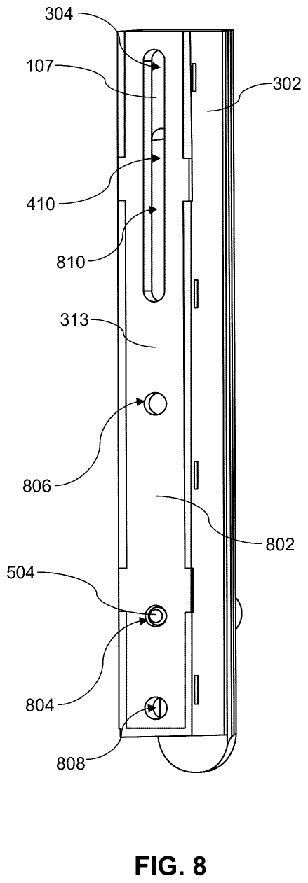

Housing 302 can include a cavity 304 to receive bolt 107. Housing 302 can include an outward facing surface 312 configured to face away from a stile in which bolt lock 106 is installed. Housing 302 can include an opening 306 in outward facing surface 312 that exposes a portion of cavity 304. In some embodiments, housing 302 can include a first hole 308 in outward facing surface 312 to receive a first fastener for attachment to a door, for example, to a stile. In some embodiments, housing 302 can include a second hole 310 in outward facing surface 312 to receive a second fastener for attachment to the door, for example to the stile. First hole 308 can be aligned with a hole (e.g., a first rear hole 808 shown in FIG. 8) in an inward facing surface 313 of housing 302 to allow passage of the first fastener through the entire housing 302. Second hole 310 can be aligned with a hole (e.g., first hole 410 shown in FIG. 4) of bolt 107 and a hole (e.g., a second rear hole 810 shown in FIG. 8) in inward facing surface 313 of housing 302 to allow passage of the second fastener through the entire housing 302 and bolt 107.

Bolt lock 106 can include bolt 107 at least partially within cavity 304. Bolt 107 can translate between a retracted position and an extended position along a translation axis A1, relative to housing 302, in response to manual engagement via opening 306 (e.g., using knob 202).

In some embodiments, bolt 107 can be made of any of the materials discussed above for housing 302. In some embodiments, bolt 107 can be made of a same material as housing 302. In some embodiments, bolt 107 can be made of a different material from housing 302.

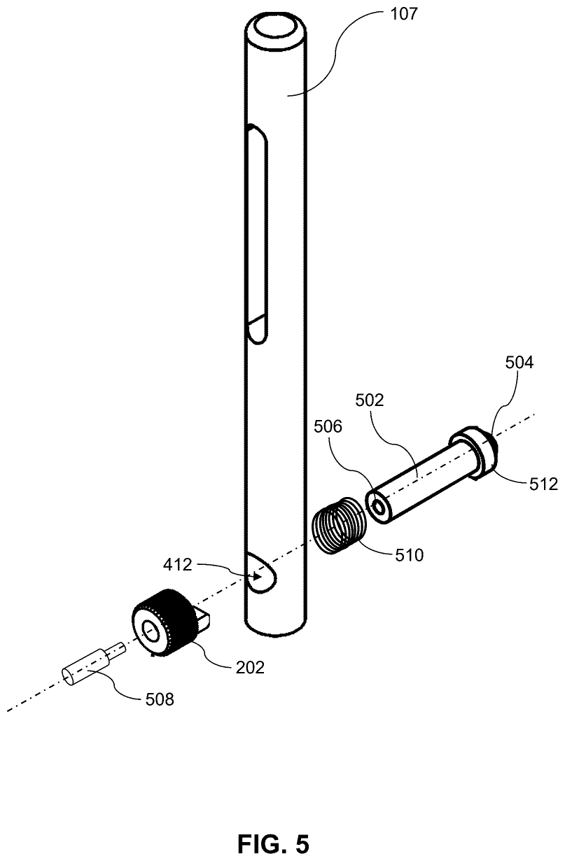

In some embodiments, bolt 107 translating between the retracted position and the extended position requires both (i) movement of knob 202 along a first linear axis A₂ perpendicular to the translation axis A1 of bolt 107 and (ii) movement of knob 202 along a second linear axis A₃ parallel to the translation axis A1 of the bolt. Configurations that enable this function are described in more detail with respect to FIGS. 5-7 and 8.

In some embodiments, knob 202 need not move along any nonlinear path to translate bolt 107 between the retracted position and the extended position. In other words, knob 202 need not rotate or pivot relative to housing 302 in some embodiments.

FIG. 4 shows a bolt 107 according to some embodiments. Bolt 107 can include a first end 402, a second end 404, and a longitudinal axis 406 extending from first end 402 to second end 404. In some embodiments, longitudinal axis 406 of bolt 107 can be aligned with translation axis A₁ shown in FIG. 3. In some embodiments, bolt 107 can be a single, integral piece from first end 402 to second end 404.

Bolt 107 can include a cross-section 408 taken perpendicular to longitudinal axis 406. In some embodiments, cross-section 408 can be substantially circular. As used herein, the term “substantially circular” refers to a shape having a diameter that does not vary by more than ±15%. That is, the maximum diameter of a substantially circular cross-section 408 is not more than 15% greater than the minimum diameter of the substantially circular cross-section 408 (i.e., not more than 115% of the minimum diameter). In some embodiments, cross-section 408 can be substantially rectangular. In some embodiments, cross-section 408 can be substantially square. In some embodiments, cross-section 408 can be substantially the shape of any regular polygon (e.g., a pentagon, hexagon, octagon, etc.). Depending on the number of its sides, the regular polygon may be considered substantially circular according to the above definition. In some embodiments, the maximum diameter of cross-section 408 is not more than 20%, not more than 30%, not more than 40%, not more than 50%, not more than 60%, not more than 70%, not more than 80%, not more than 90%, or not more than 100% greater than the minimum diameter of cross-section 408.

In some embodiments, a diameter of cross-section 408 (i.e., of bolt 107) can be greater than or equal to 0.4 inches and less than or equal to 1 inch. More specifically, in some embodiments, the diameter can be greater than or equal to 0.4 inches and less than or equal to 0.8 inches, greater than or equal to 0.4 inches and less than or equal to 0.6 inches, or about 0.5 inches. In some embodiments, the diameter can be greater than or equal to 1 inch and less than or equal to 2 inches.

In some embodiments, bolt 107 can include a first hole 410 to receive a fastener and allow bolt 107 to translate relative to the fastener between the retracted position and the extended position. That is, first hole 410 can receive a fastener that passes through housing 302 (particularly, passing through holes 310 in outward facing surface 312 and 810 in inward facing surface 313) to attach bolt lock 106 to a stile. Accordingly, first hole 410 can allow for both attachment of bolt lock 106 to the stile and translation of bolt 107 between the retracted position and the extended position.

In some embodiments, first hole 410 can have a length L_{H1}, as measured along longitudinal axis 406, greater than or equal to 1.5 inches and less than or equal to 4 inches. More specifically, in some embodiments, L_{H1} can be greater than or equal to 1.5 inches and less than or equal to 3 inches, greater than or equal to 1.5 inches and less than or equal to 2.5 inches, greater than or equal to 1.75 inches and less than or equal to 2.25 inches, greater than or equal to 2 inches and less than or equal to 4 inches, or about 2 inches. In some embodiments, L_{H1} can be greater than or equal to 4 inches and less than or equal to 6 inches.

L_{H1} can correspond to the distance between the position of second end 404 of bolt 107 in the retracted position versus in the extended position. In some embodiments, L_{H1} can correspond to the distance bolt 107 extends beyond housing 302 in the extended position. In embodiments in which housing 302 is substantially aligned with a top edge 118 or bottom edge 120 of first door 100a, L_{H1} can correspond to the distance bolt 107 extends beyond the top or bottom edge 118, 120 of first door 100a in the extended position. Accordingly, the larger L_{H1} is, the farther bolt 107 can extend into and/or through frame 105.

In some embodiments, bolt 107 can have a length L_{B}, as measured along longitudinal axis 406 from first end 402 to second end 404, greater than or equal to 4 inches and less than or equal to 8 inches. More specifically, in some embodiments, L_{B} can be greater than or equal to 4.5 inches and less than or equal 7.5 inches, greater than or equal to 5 inches and less than or equal to 7 inches, greater than or equal to 5.5 inches and less than or equal to 6.5 inches, or about 6 inches. In some embodiments, L_{B} can be greater than or equal to 8 inches and less than or equal to 10 inches.

In some embodiments, bolt 107 can include a second hole 412. Second hole 412 can be positioned between first hole 410 and first end 402 of bolt 107. In some embodiments, second hole 412 need not extend through bolt 107 and can receive a pin 502 (shown in FIG. 5) that extends only partially through bolt 107.

FIG. 5 shows knob 202 and pin 502 configured for engagement with second hole 412, according to some embodiments.

In some embodiments, bolt lock 106 can include pin 502. Pin 502 can extend into second hole 412 of bolt 107. In some embodiments, pin 502 can extend through second hole 412. Pin 502 can include a first end 504 adjacent a rear wall of housing 302 of bolt lock 106 when installed and a second end 506 adjacent opening 306 of housing 302 when installed.

Knob 202 can be coupled to second end 506 of pin 502. In some embodiments, knob 202 can be coupled to second end 506 using a spindle 508 that is either integrally formed with or coupled to knob 202. In some embodiments, spindle 508 can include a threaded surface that is inserted into second end 506 of pin 502 and engages with a threaded interior surface of pin 502. In some embodiments spindle 508 can be a bolt or screw. However, any suitable means for coupling knob 202 to pin 502 can be implemented. For example, in some embodiments, knob 202 can be coupled to pin 502 via welding. In some embodiments, knob 202 can be integrally formed with pin 502.

In some embodiments, bolt lock 106 can include a spring 510 to provide a force biasing knob 202 toward bolt 107. In some embodiments, pin 502 can be threaded through spring 510, which can engage with a head 512 of pin 502. In some embodiments, spring 510 can be trapped between head 512 and bolt 107 to provide the force biasing knob 202 toward bolt 107, and in this case first end 504 of pin 502 away from bolt 107. Accordingly, a user can experience a resistance when pulling knob 202 away from bolt 107 along first linear axis A₂ shown in FIG. 3.

The configuration of pin 502, knob 202, and spring 510 shown in FIG. 5 is an example configuration shown to illustrate the biasing of knob 202 toward bolt 107. Any configuration that biases knob 202 toward bolt 107 and/or first end 504 of pin 502 away from bolt 107 is contemplated.

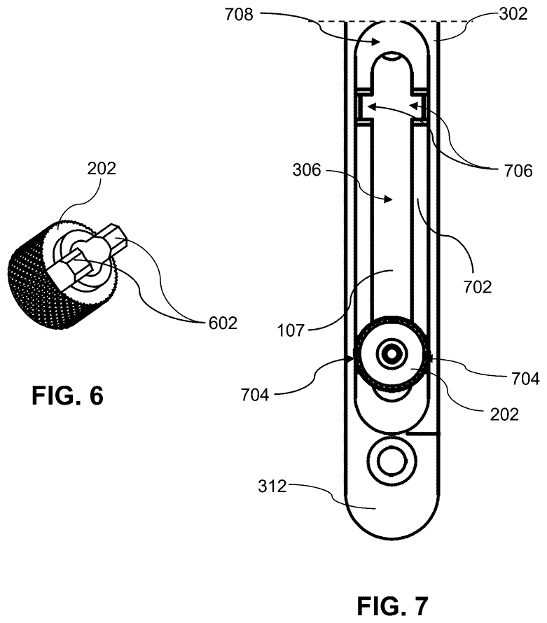

In some embodiments, spring 510 can bias pin 502 and/or knob 202 to a position of engagement with housing 302 that prevents bolt 107 from translating relative to housing 302, as shown in FIGS. 6-8 according to some embodiments.

FIG. 6 shows knob 202 according to some embodiments. In some embodiments, knob 202 can include one or more protrusions 602. For example, knob 202 can include two protrusions 602 forming ridges on a bolt 107-facing side of knob 202.

FIG. 7 shows a portion of bolt lock 106 according to some embodiments. In some embodiments, housing 302 of bolt lock 106 can include a first recess portion 704 to receive the one or more protrusions 602 when bolt 107 is in the retracted position. In some embodiments, housing 302 can include a second recess portion 706 to receive the one or more protrusions 602 when bolt 107 is in the extended position. In embodiments in which the one or more protrusions 602 include two protrusions 602, first and second recess portions 704, 706 can both include a pair of recesses to receive the two protrusions 602, as shown in FIG. 7. In some embodiments, first and second recess portions 704, 706 can be formed in a rim 702 of opening 306.

In some embodiments, housing 302 can include a third recess portion 708 comprising rim 702. Third recess portion 708 can be recessed from remaining portions of outward facing surface 312 of housing 302 and can extend between first and second recess portions 704, 706. In some embodiments, at least a portion of knob 202 (e.g., protrusion(s) 602) can be positioned within third recess portion 708 as bolt 107 translates between the retracted position and the extended position.

FIG. 8 shows a rear wall 802 of housing 302 according to some embodiments. In some embodiments, rear wall 802 can include a first recess 804 to receive first end 504 of pin 502 when bolt 107 is in the retracted position. In some embodiments, rear wall 802 can include a second recess 806 to receive first end 504 of pin 502 when bolt 107 is in the extended position. In some embodiments, first and second recesses 804, 806 each include a hole in rear wall 802. However, in some embodiments, first and second recesses 804, 806 can each merely include an indentation in rear wall 802 within cavity 304.

The biasing of knob 202 toward bolt 107 can cause engagement of knob 202 with housing 302 to prevent bolt 107 from translating relative to housing 302. For example, protrusion(s) 602 can engage with first recess portion 704 when bolt 107 is in the retracted position and thereby prevent translation of bolt 107 relative to housing 302. However, a user can pull knob 202 away from bolt 107 to disengage protrusion(s) 602 from first recess portion 704, translate knob 202 to second recess portion 706, thereby translating bolt 107 to the extended position, and release knob 202 to engage protrusion(s) 602 with second recess portion 706 to lock bolt 107 relative to housing 302 once again.

Likewise, the biasing of first end 504 away from bolt 107 can cause engagement of first end 504 of pin 502 with housing 302 to prevent bolt 107 from translating relative to housing 302. For example, first end 504 can engage with first recess 804 when bolt 107 is in the retracted position and thereby prevent translation of bolt 107 relative to housing 302. However, a user can pull knob 202 away from bolt 107 to disengage first end 504 from first recess 804, translate knob 202 and pin 502 to second recess 806, thereby translating bolt 107 to the extended position, and release knob 202 to engage first end 504 with second recess 806 to lock bolt 107 relative to housing 302 once again.

Accordingly, the features shown in FIGS. 5-7 and/or 8 can cause bolt 107 translating between the retracted position and the extended position to require movement of knob 202 along first linear axis A₂ and second linear axis A₃ shown in FIG. 3.

In some embodiments, bolt lock 106 can include both first and second recesses 804, 806 for engagement with pin 502 and first and second recess portions 704, 706/protrusion(s) 602. In some embodiments, bolt lock 106 can include only first and second recesses 804, 806 for engagement with pin 502, and not first and second recess portions 704, 706/protrusion(s) 602. In some embodiments, bolt lock 106 can include only first and second recess portions 704, 706/protrusion(s) 602, and not first and second recesses 804, 806 for engagement with pin 502.

In some embodiments, bolt lock 106 can include none of these features and knob 202 can be statically coupled to bolt 107 (e.g., with no biasing via a spring 510). In such embodiments, only movement of knob 202 along second linear axis A₃ may be required to translate bolt 107 from the retracted position to the extended position.

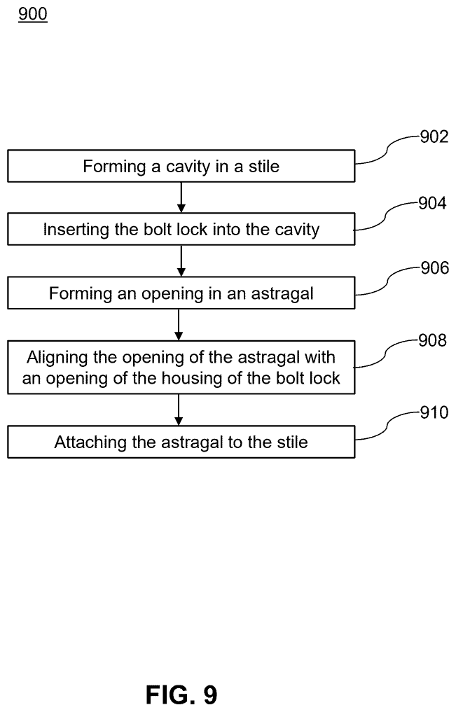

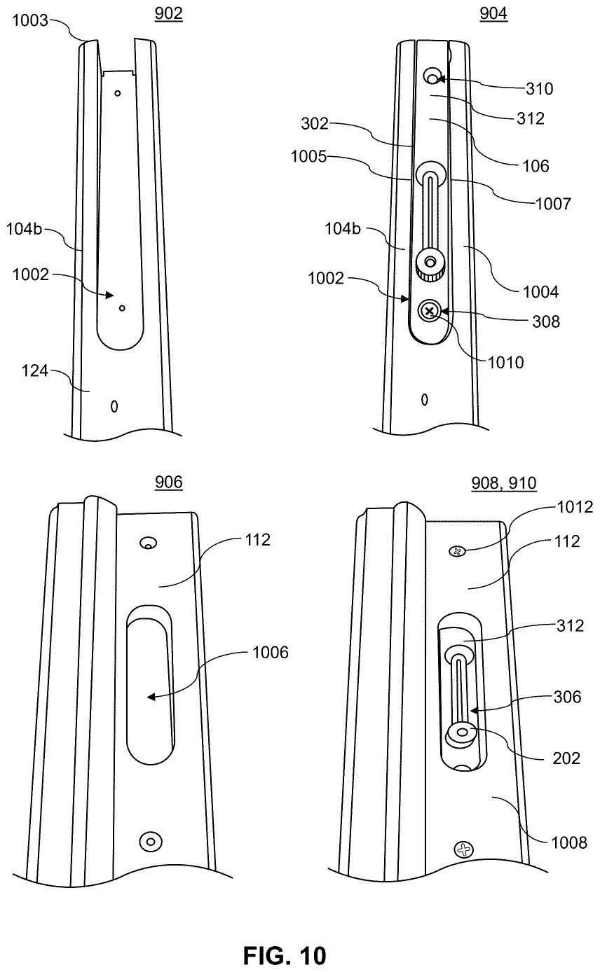

FIGS. 9-10 show a method 900 of installing bolt lock 106 according to some embodiments. Unless stated otherwise, the steps of method 900 need not be performed in the order set forth herein. Additionally, unless otherwise specified, the steps of method 900 need not be performed sequentially. The steps can be performed in a different order or simultaneously. As one example, step 906 need not be performed after step 902, but can be performed before step 902. Further, method 900 need not comprise all the steps illustrated.

Steps 902-910 are described with reference to FIG. 10.

Step 902 can include forming a cavity 1002 in a stile (e.g., second stile 104b). In some embodiments, the stile can be part of a door, for example, of a double door configuration. In some embodiments, the stile can be part of a window.

In some embodiments, cavity 1002 can extend to an edge 1003 of the stile. In some embodiments, edge 1003 can be a top edge of the stile (e.g., partially defining top edge 118 of door 100a). In some embodiments, edge 1003 can be a bottom edge of the stile (e.g., partially defining bottom edge 120 of door 100a). In some embodiments, cavity 1002 need not extend to edge 1003, but instead a hole can be drilled from cavity 1002 to edge 1003 to allow passage of bolt 107 out of the stile into the extended position.

In some embodiments, cavity 1002 can be formed by routing the stile.

Step 904 can include inserting bolt lock 106 into cavity 1002. In some embodiments, outward facing surface 312 of bolt lock 106 can be substantially even with a surface 1004 of the stile when bolt lock 106 is installed in cavity 1002. In some embodiments, outward facing surface 312 of bolt lock 106 can be recessed from surface 1004 when bolt lock 106 is installed in cavity 1002. In some embodiments, cavity 1002 and bolt lock 106 can be positioned such that portions of the stile are on both a first side 1005 and a second side 1007 of housing 302, the first and second sides 1005, 1007 being connected by outward facing surface 312.

Step 906 can include forming an opening 1006 in an astragal (e.g., astragal 112).

In some embodiments, opening 1006 can be formed by routing the astragal.

Step 908 can include aligning opening 1006 of the astragal with opening 306 of housing 302. Aligning opening 1006 with opening 306 can be mean causing the perimeter of opening 1006 to fully encompass the perimeter of opening 306. This can correspond with opening 1006 being aligned with the first knob 202 position and the second knob 202 position, which correspond with bolt 107 being in the retracted and extended positions, respectively.

Step 910 can include attaching the astragal to the stile. Knob 202 can translate within opening 1006 of the astragal when the astragal is attached.

The astragal can include an outward facing surface 1008 configured to face away from the stile and defining a plane. In some embodiments, knob 202 does not break the plane when the astragal is attached to the stile. In some embodiments, knob 202 can be substantially even with the plane when the astragal is attached to the stile.

In some embodiments, the astragal can cover a portion of bolt lock 106 when the astragal is attached to the stile. In some embodiments, the astragal can cover greater than or equal to 25 percent of the area of the outward facing surface 312 of housing 302 when the astragal is attached to the stile. More specifically, in some embodiments, the astragal can cover greater than or equal to 30 percent, greater than or equal to 40 percent, greater than or equal to 50 percent, greater than or equal to 60 percent, greater than or equal to 70 percent, greater than or equal to 80 percent, or greater than or equal to 90 percent of the area of the outward facing surface 312 of housing 302 when the astragal is attached to the stile.

In some embodiments, method 900 can include attaching bolt lock 106 to the stile by inserting a first fastener 1010 through first hole 308 in outward facing surface 312 of housing 302, through first rear hole 808 in inward facing surface 313 of housing 302, and into the stile, without inserting first fastener 1010 through the astragal, as shown in FIG. 10 (step 904). In some embodiments, method 900, for example, step 910, can include attaching the astragal to the stile and further attaching bolt lock 106 to the stile by inserting a second fastener 1012 through the astragal, through second hole 310 in outward facing surface 312 of housing 302, through first hole 410 of bolt 107, through second rear hole 810 in inward facing surface 313 of housing 302, and into the stile, as shown in FIG. 10 (step 910).

In some embodiments, steps 906, 908, and 910 can be omitted. In other words, a door having bolt lock 106 may not have an astragal in some embodiments. In such embodiments, second fastener 1012 is not inserted through an astragal.

While FIG. 10 shows bolt lock 106 being installed in second side edge 124 of a door 100a, bolt lock 106 can be installed in any surface of a stile.

Bolt locks, for example, flush bolt locks, are often installed on an outside surface of a door edge, where their entire outward facing surfaces are visible. At least partially embedding a bolt lock in a stile and covering a portion of the bolt lock with an astragal, as shown in FIGS. 2 and 10, provides a more aesthetically pleasing door. This is because the astragal can hide components of the bolt lock and selectively expose components necessary for operating the bolt lock.

Additionally, the use of a knob that must translate along two linear axes (e.g., A₂ and A₃ described herein) to translate the bolt from the retracted to the extended position can increase the security of the bolt lock. In such a configuration, it is more difficult to access and operate the bolt lock using, for example, a hanger or other tool that an intruder may use to operate a bolt lock in an unauthorized manner.

Finally, the size and shape of the bolt described herein can increase security against an intruder or storm. For example, a substantially cylindrical bolt approximately 0.5 inches in diameter having an approximately 2 inch extension distance can provide greater security than existing flush bolt locks, which have bolts that typically extend less than an inch and are often flat in shape. Such a lengthened extension distance can be achieved by forming a hole (e.g., first hole 410) in the bolt having a length of about 2 inches.

The foregoing description of the specific embodiments described with reference to the figures will so fully reveal the general nature of the disclosure that others can, by applying knowledge within the skill of the art, readily modify or adapt for various applications such specific embodiments, without undue experimentation, without departing from the general concept of this disclosure.

While various embodiments of this disclosure have been described above, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of this disclosure. The elements of the embodiments presented above are not necessarily mutually exclusive, but can be interchanged to meet various needs as would be appreciated by one of skill in the art.

It is to be understood that the phraseology or terminology used herein is for the purpose of description and not of limitation. The breadth and scope of this disclosure should not be limited by any of the above-described exemplary embodiments but should be defined only in accordance with the following claims and their equivalents.

It is to be appreciated that the Detailed Description section, and not the Summary and Abstract sections, is intended to be used to interpret the claims. The Summary and Abstract sections can set forth one or more but not all exemplary embodiments of the present invention(s) as contemplated by the inventor(s), and thus, are not intended to limit the present invention(s) and the appended claims in any way.

What is claimed is:

1. A bolt lock for a door, comprising:
a housing comprising:
a cavity, and
an opening exposing a portion of the cavity;
a bolt at least partially within the cavity, the bolt translating between a retracted position and an extended position along a translation axis, relative to the housing, in response to manual engagement via the opening, the bolt comprising:
a first end,
a second end to selectively engage a recess of a door frame,
a longitudinal axis extending from the first end to the second end,
a substantially circular cross section, and
a first hole to receive a fastener and allow the bolt to translate relative to the fastener between the retracted position and the extended position, the first hole having a length, as measured along the longitudinal axis, greater than or equal to 1.5 inches and less than or equal to 4 inches.

2. The bolt lock of claim 1, the bolt further comprising a second hole positioned between the first hole and the first end of the bolt,
the bolt lock further comprising:
a pin extending into the second hole of the bolt, the pin comprising:
a first end adjacent a rear wall of the housing, and
a second end adjacent the opening of the housing;
a knob coupled to the second end for the manual engagement; and
a spring biasing at least one of the pin or the knob to a position of engagement with the housing that prevents the bolt from translating relative to the housing.

3. The bolt lock of claim 2, the rear wall of the housing comprising:
a first recess to receive the first end of the pin when the bolt is in the retracted position; and
a second recess to receive the first end of the pin when the bolt is in the extended position.

4. The bolt lock of claim 3, wherein the first and second recesses each comprise a hole in the rear wall of the housing.

5. The bolt lock of claim 2, the knob comprising a first protrusion and the housing further comprising:
a first recess portion to receive the first protrusion when the bolt is in the retracted position; and
a second recess portion to receive the first protrusion when the bolt is in the extended position.

6. The bolt lock of claim 5, the housing further comprising a third recess portion extending between the first and second recess portions, wherein at least a portion of the knob is positioned within the third recess portion as the bolt translates between the retracted position and the extended position.

7. The bolt lock of claim 5, wherein:
the knob further comprises a second protrusion; and
the first and second recess portions each comprise a pair of recesses to receive the first and second protrusions.

8. The bolt lock of claim 1, the bolt being a single, integral piece from the first end to the second end.

9. The bolt lock of claim 1, wherein the length of the first hole is greater than or equal to 2 inches.

10. The bolt lock of claim 1, wherein the bolt comprises a diameter, as measured perpendicular to the longitudinal axis, greater than or equal to 0.4 inches and less than or equal to 1 inch.

11. The bolt lock of claim 1, further comprising a knob coupled to the bolt for the manual engagement, wherein the bolt translating between the retracted position and the extended position requires movement of the knob along a first linear axis perpendicular to the translation axis of the bolt and a second linear axis parallel to the translation axis of the bolt.

12. A door comprising:
a stile comprising a cavity;
a bolt lock at least partially within the cavity, the bolt lock comprising:
a housing comprising:
a cavity; and
an outward facing surface facing away from the stile;
a knob that translates between a first knob position and a second knob position; and
a bolt coupled to the knob and at least partially within the cavity of the housing, the bolt translating between a retracted position and an extended position along a translation axis, relative to the housing, in response to manual engagement of the knob from the first knob position to the second knob position; and
an astragal attached to the stile and covering a portion of the bolt lock, the astragal comprising:
an opening aligned with the first and second knob positions, the knob translating within the opening of the astragal.

13. The door of claim 12, the astragal comprising an outward facing surface facing away from the stile and defining a plane, wherein the knob does not break the plane when the bolt is in the retracted position and the extended position.

14. The door of claim 12, wherein the outward facing surface of the housing is substantially even with a surface of the stile.

15. The door of claim 12, wherein the astragal covers greater than or equal to 25 percent of the area of the outward facing surface of the housing.

16. The door of claim 12, wherein the bolt translating between the retracted position and the extended position requires movement of the knob along a first linear axis perpendicular to the translation axis of the bolt and a second linear axis parallel to the translation axis of the bolt.

17. The door of claim 12, wherein the bolt extends beyond an edge of the door in the extended position by a distance of greater than or equal to 1.5 inches and less than or equal to 4 inches.

18. The door of claim 17, wherein the distance is greater than or equal to 1.75 inches and less than or equal to 2.25 inches.

19. A method of installing a bolt lock, the method comprising:
forming a cavity in a stile;
inserting the bolt lock into the cavity, the bolt lock comprising:
a housing comprising:
a cavity;
an outward facing surface configured to face away from the stile; and
an opening exposing a portion of the cavity of the housing,
a bolt at least partially within the cavity of the housing, and
a knob coupled to the bolt adjacent the opening, the bolt translating between a retracted position and an extended position, relative to the housing, in response to manual engagement of the knob;
forming an opening in an astragal;
aligning the opening of the astragal with the opening of the housing; and
attaching the astragal to the stile, the knob translating within the opening of the astragal when the astragal is attached to the stile.

20. The method of claim 19, the astragal comprising an outward facing surface configured to face away from the stile and defining a plane, wherein the knob does not break the plane when the astragal is attached to the stile.

21. The method of claim 20, wherein the knob is substantially even with the plane when the astragal is attached to the stile.

22. The method of claim 19, wherein the astragal covers greater than or equal to 25 percent of the area of the outward facing surface of the housing when the astragal is attached to the stile.

23. The method of claim 19, the bolt comprising:
a first end;
a second end to selectively engage a recess of a frame;
a longitudinal axis extending from the first end to the second end; and
a hole having a length, as measured along the longitudinal axis, greater than its width;
the housing further comprising:
a first hole to receive a first fastener; and
a second hole to receive a second fastener, the second hole of the housing being aligned with the hole of the bolt,
wherein the method further comprises:
attaching the bolt lock to the stile by inserting the first fastener through the first hole of the housing into the stile, without inserting the first fastener through the astragal; and
attaching the astragal to the stile and further attaching the bolt lock to the stile by inserting the second fastener through the astragal, through the second hole of the housing, and through the hole of the bolt into the stile.

24. The method of claim 19, wherein the cavity extends to a top or a bottom edge of the stile.
